(19) United States
(12) Patent Application Publication
(10) Pub. No.: US 2024/0302196 A1
(43) Pub. Date: Sep. 12, 2024

(54) VOLUME MEASUREMENT DEVICE, VOLUME MEASUREMENT SYSTEM, AND VOLUME MEASUREMENT METHOD

(71) Applicant: NEC Corporation, Minato-ku, Tokyo (JP)

(72) Inventors: Ryuuta ABE, Tokyo (JP); Takuno NAKAJIMA, Tokyo (JP); Toshiki SAITO, Tokyo (JP); Yosuke KAKUNO, Tokyo (JP); Tsuyoshi KUMAGAI, Tokyo (JP); Kyoko MAGOME, Tokyo (JP)

(73) Assignee: NEC Corporation, Minato-ku, Tokyo (JP)

(21) Appl. No.: 18/572,912

(22) PCT Filed: Jun. 28, 2022
(86) PCT No.: PCT/JP2022/025716

§ 371 Date: Dec. 21, 2023

(30) Foreign Application Priority Data
Jun. 29, 2021 (JP) 2021-107252

(51) Int. Cl. G01F 17/00; G01B 11/03; G01B 11/22

(52) U.S. Cl. CPC G01F 17/00; G01B 11/03; G01B 11/22

(57) ABSTRACT

In order to obviate the need for measurement by a distance sensor in an unloaded state when measuring the volume of a load, this volume measurement device comprises: a first distance data acquisition unit for acquiring first distance data from above; a second distance data acquisition unit for acquiring second distance data associated with a back surface part and a side surface part of the bed, as well as the ground surface; a first identifying unit for identifying a frame of the bed using the first distance data; a second identifying unit for identifying the position of a bottom surface part of the bed using the second distance data; and a volume measurement unit for measuring the volume of a load on the bed on the basis of the results of identification by the first identifying unit and the second identifying unit.

### TECHNICAL FIELD

The present invention relates to a volume measurement device and the like.

### BACKGROUND ART

A technique for measuring a cubic volume (hereinafter, referred to as a “volume”) of a load on a bed (for example, a dump truck vessel) of a freight car (for example, a dump truck) by using a distance sensor (for example, an ultrasonic sensor) being arranged above the freight car is known. PTL 1 discloses the technique.

In the technique described in PTL 1, a surface shape of a freight car including a load is measured by using a distance sensor, in a state where the load is loaded on a bed of the freight car. Further, a surface shape of the freight car is measured by using the distance sensor, in a state where no load is loaded (a so-called “unloaded” state) on the bed of the freight car. Then, a volume of the load is computed based on a difference between the surface shapes (see paragraphs to [0017], FIGS. 1 and 2, and the like in PTL 1).

Note that, a technique described in PTL 2 is also known as a related art.

### CITATION LIST

### Patent Literature

PTL 1: Japanese Unexamined Patent Application Publication No. 2005-233643
PTL 2: Japanese Unexamined Patent Application Publication No. S62-284207

### SUMMARY OF INVENTION

### Technical Problem

In the technique described in PTL 1, it is required to execute measurement using a distance sensor in a state where a load is loaded on a bed of a freight car. In addition thereto, there is a problem that it is required to execute measurement using the distance sensor in an unloaded state.

In view of the above-described problem, an object of the present invention is to eliminate need for measurement by a distance sensor in an unloaded state, upon measuring a volume of a load by using the distance sensor.

### Solution to Problem

A volume measurement device according to the present invention includes: a first distance data acquisition unit that acquires first distance data acquired by a first distance sensor that irradiates a bed of a freight vehicle with a first searching wave from above; a second distance data acquisition unit that acquires second distance data acquired by a second distance sensor that irradiates at least one of a back surface portion and a side surface portion of the bed and a ground surface around the freight vehicle with a second searching wave; a first identifying unit that identifies a frame associated with a peripheral wall portion of the bed by using the first distance data; a second identifying unit that identifies a position of a bottom surface portion of the bed relative to the ground surface by using the second distance data; and a volume measurement unit that measures a volume of a load on the bed by using the first distance data, based on a result of identification by the first identifying unit and the second identifying unit.

A volume measurement system according to the present invention includes: a first distance data acquisition unit that acquires first distance data acquired by a first distance sensor that irradiates a bed of a freight vehicle with a first searching wave from above; a second distance data acquisition unit that acquires second distance data acquired by a second distance sensor that irradiates at least one of a back surface portion and a side surface portion of the bed and a ground surface around the freight vehicle with a second searching wave; a first identifying unit that identifies a frame associated with a peripheral wall portion of the bed by using the first distance data; a second identifying unit that identifies a position of a bottom surface portion of the bed relative to the ground surface by using the second distance data; and a volume measurement unit that measures a volume of a load on the bed by using the first distance data, based on a result of identification by the first identifying unit and the second identifying unit.

A volume measurement method according to the present invention includes: acquiring, by a first distance data acquisition unit, first distance data acquired by a first distance sensor that irradiates a bed of a freight vehicle with a first searching wave from above; acquiring, by a second distance data acquisition unit, second distance data acquired by a second distance sensor that irradiates at least one of a back surface portion and a side surface portion of the bed and a ground surface around the freight vehicle with a second searching wave; identifying, by a first identifying unit, a frame associated with a peripheral wall portion of the bed by using the first distance data; identifying, by a second identifying unit, a position of a bottom surface portion of the bed relative to the ground surface by using the second distance data; and measuring, by a volume measurement unit, a volume of a load on the bed by using the first distance data, based on a result of identification by the first identifying unit and the second identifying unit.

A recording medium according to the present invention records a program causing a computer to function as: a first distance data acquisition unit that acquires first distance data acquired by a first distance sensor that irradiates a bed of a freight vehicle with a first searching wave from above; a second distance data acquisition unit that acquires second distance data acquired by a second distance sensor that irradiates at least one of a back surface portion and a side surface portion of the bed and a ground surface around the freight vehicle with a second searching wave; a first identifying unit that identifies a frame associated with a peripheral wall portion of the bed by using the first distance data; a second identifying unit that identifies a position of a bottom surface portion of the bed relative to the ground surface by using the second distance data; and a volume measurement unit that measures a volume of a load on the bed by using the first distance data, based on a result of identification by the first identifying unit and the second identifying unit.

### Advantageous Effects of Invention

The present invention can eliminate need for measurement by a distance sensor in an unloaded state, upon measuring a volume of a load by using the distance sensor.

### BRIEF DESCRIPTION OF DRAWINGS

FIG. 1 is a block diagram illustrating a main portion of a volume measurement system according to a first example embodiment.

FIG. 2A is an explanatory diagram illustrating an example of an installation position of a first distance sensor and a second distance sensor.

FIG. 2B is an explanatory diagram illustrating an example of an installation position of the first distance sensor and the second distance sensor.

FIG. 3 is a block diagram illustrating a hardware configuration of a main portion of a volume measurement device according to the first example embodiment.

FIG. 4 is a block diagram illustrating another hardware configuration of a main portion of the volume measurement device according to the first example embodiment.

FIG. 5 is a block diagram illustrating another hardware configuration of a main portion of the volume measurement device according to the first example embodiment.

FIG. 6 is a flowchart illustrating an operation of the volume measurement device according to the first example embodiment.

FIG. 7A is a flowchart illustrating a detailed operation of a first distance data acquisition unit and a first identifying unit in the volume measurement device according to the first example embodiment.

FIG. 7B is a flowchart illustrating a detailed operation of the first distance data acquisition unit and the first identifying unit in the volume measurement device according to the first example embodiment.

FIG. 8 is an explanatory diagram illustrating an example of a group of points included in first distance data.

FIG. 9 is an explanatory diagram illustrating an example of an approximate straight line associated with a right side surface portion of a freight vehicle.

FIG. 10A is an explanatory diagram illustrating an example of a state before a tilt of a stop direction of the freight vehicle is corrected.

FIG. 10B is an explanatory diagram illustrating an example of a state after a tilt of a stop direction of the freight vehicle is corrected.

FIG. 11 is an explanatory diagram illustrating an example of a state where an XY-coordinate system is divided into a plurality of blocks in order to generate a grayscale image.

FIG. 12 is an explanatory diagram illustrating an example of a binary image converted from the grayscale image.

FIG. 13A is a flowchart illustrating a detailed operation of a second distance data acquisition unit and a second identifying unit in the volume measurement device according to the first example embodiment.

FIG. 13B is a flowchart illustrating a detailed operation of the second distance data acquisition unit and the second identifying unit in the volume measurement device according to the first example embodiment.

FIG. 14A is an explanatory diagram illustrating an example of a range to be irradiated with a searching wave by the second distance sensor.

FIG. 14B is an explanatory diagram illustrating an example of an XY-plane, an XZ-plane, and a YZ-plane.

FIG. 15 is an explanatory diagram illustrating an example of a bottom surface height.

FIG. 16A is a flowchart illustrating a detailed operation of a volume measurement unit and an output control unit in the volume measurement device according to the first example embodiment.

FIG. 16B is a flowchart illustrating a detailed operation of the volume measurement unit and the output control unit in the volume measurement device according to the first example embodiment.

FIG. 17A is an explanatory diagram illustrating an example of a bed frame.

FIG. 17B is an explanatory diagram illustrating an example of a cell.

FIG. 17C is an explanatory diagram illustrating an example of a depth value.

FIG. 17D is an explanatory diagram illustrating an example of a volume of a load in an individual cell.

FIG. 18 is a block diagram illustrating a main portion of volume measurement according to a second example embodiment.

FIG. 19 is a block diagram illustrating a main portion of a volume measurement system according to the second example embodiment.

### EXAMPLE EMBODIMENT

Hereinafter, example embodiments of the present invention will be descried in detail with reference to the accompanying drawings. [First Example Embodiment]

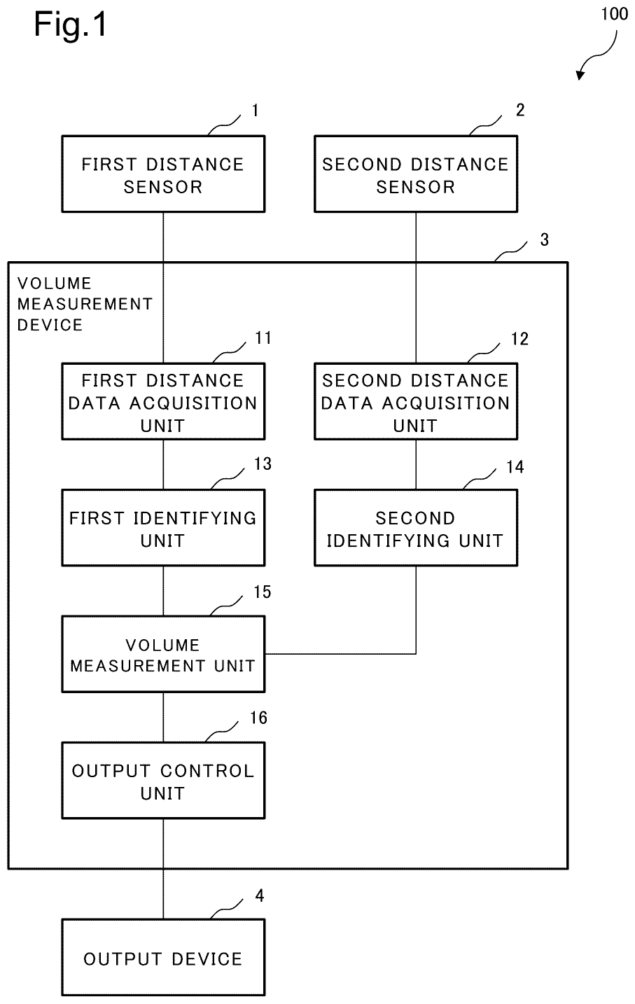

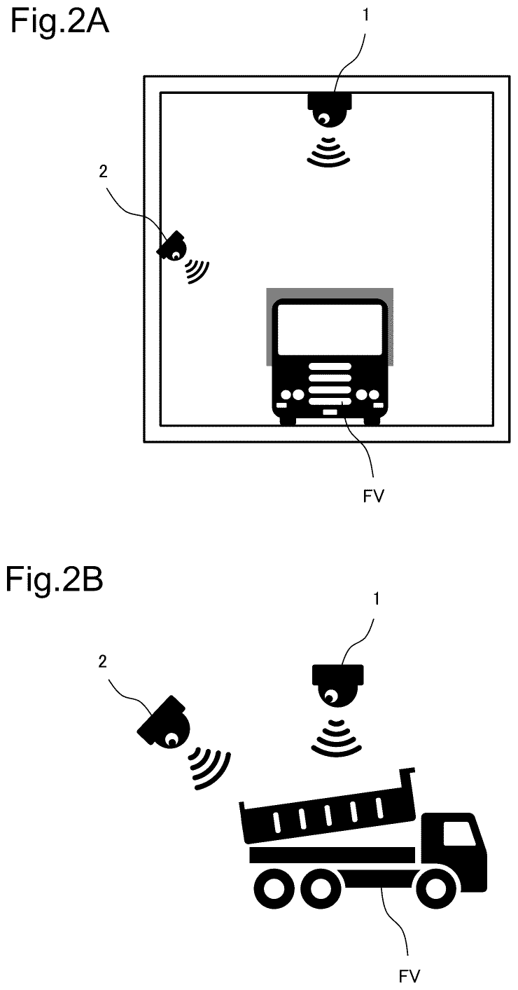

FIG. 1 is a block diagram illustrating a main portion of a volume measurement system according to a first example embodiment. FIGS. 2A and 2B are explanatory diagrams illustrating an example of an installation position of a first distance sensor and a second distance sensor. The volume measurement system according to the first example embodiment will be described with reference to FIGS. 1 to 2B.

As illustrated in FIG. 1, a volume measurement system 100 includes a first distance sensor 1, a second distance sensor 2, a volume measurement device 3, and an output device 4. The volume measurement device 3 includes a first distance data acquisition unit 11, a second distance data acquisition unit 12, a first identifying unit 13, a second identifying unit 14, a volume measurement unit 15, and an output control unit 16.

Each of the first distance sensor 1 and the second distance sensor 2 is configured by, for example, 3D-light detection and ranging (LiDAR), a millimeter wave radar, a time of flight (ToF) camera, or an ultrasonic sensor. Hereinafter, a wave (laser light, a millimeter wave, an infrared ray, an ultrasonic wave, or the like) used in measurement of a distance by each of the first distance sensor 1 and the second distance sensor 2 may be referred to collectively as a “searching wave”. Hereinafter, an example of a case will be mainly described in which each of the first distance sensor 1 and the second distance sensor 2 is configured by 3D-LiDAR and the searching wave is laser light.

As illustrated in FIGS. 2A and 2B, the first distance sensor 1 is arranged above a freight vehicle FV (for example, a dump truck) in a state where the freight vehicle FV is stopped at a predetermined position in a predetermined orientation. The first distance sensor 1 emits a first searching wave toward a bed (for example, a dump truck vessel) of the freight vehicle FV below. Thereby, at least the bed (for example, the dump truck vessel) of the freight vehicle FV is irradiated by the first distance sensor 1 with the first searching wave from above. In addition thereto, a ground surface around the freight vehicle V may be irradiated by the first distance sensor 1 with the first searching wave. Note that, when irradiated by the first distance sensor 1 with the searching wave, the bed of the freight vehicle FV is loaded with a load. That is, irradiation with the searching wave in an unloaded state is unnecessary. Herein, the “first searching wave” is a searching wave for irradiation by the first distance sensor 1. The first searching wave with which the objects (the bed, the load, the ground surface, and the like) are irradiated is reflected by the objects.

The second distance sensor 2 is, for example, arranged at a position obliquely behind the freight vehicle FV, and is arranged obliquely downward, as illustrated in FIGS. 2A and 2B. The second distance sensor 2 irradiates at least one of a back surface portion and a side surface portion of the bed of the freight vehicle FV with a second searching wave, and irradiates the ground surface around the freight vehicle FV with the second searching wave, in a state where the freight vehicle FV is stopped at a predetermined position in a predetermined orientation. In this case, both of the back surface portion and the side surface portion of the bed of the freight vehicle FV are irradiated by the second distance sensor 2 with the second searching wave, and the ground surface around the freight vehicle FV is irradiated with the second searching wave. Note that, when irradiated by the second distance sensor 2 with the second searching wave, the bed of the freight vehicle FV is loaded with a load. That is, irradiation with the second searching wave in an unloaded state is unnecessary. Herein, the “second searching wave” is a searching wave for irradiation by the second distance sensor 2. The second searching wave with which the objects (the bed, the load, the ground surface, and the like) are irradiated is reflected by the objects.

The first distance data acquisition unit 11 acquires data acquired by measurement using the first distance sensor 1. For example, a reflected wave (backscattered light) associated with the first searching wave (laser light) emitted by the first distance sensor 1 in each direction is received by the first distance sensor 1. The first distance sensor 1 measures, for reflected waves associated with individual emission directions, a distance by using ToF or a frequency modulated continuous wave (FMCW). Thereby, a distance between a position where the first distance sensor 1 is installed and a position of a point (reflection point) where the above emitted first searching wave is reflected is measured. The first distance data acquisition unit 11 acquires group-of-points data or depth data indicating positions of individual reflection points, based on the measured distance. Hereinafter, the pieces of data may be referred to collectively as “first distance data”. Hereinafter, an example when the first distance data are group-of-points data will be mainly described.

The second distance data acquisition unit 12 acquires data acquired by measurement using the second distance sensor 2. For example, a reflected wave (backscattered light) associated with the second searching wave (laser light) emitted by the second distance sensor 2 in each direction is received by the second distance sensor 2. The second distance sensor 2 measures, for reflected waves associated with individual emission directions, a distance by using ToF or an FMCW. Thereby, a distance between a position where the second distance sensor 2 is installed and a position of a point (reflection point) where the above emitted second searching wave is reflected is measured. The second distance data acquisition unit 12 acquires group-of-points data or depth data indicating positions of individual reflection points, based on the measured distance. Hereinafter, the pieces of data may be referred to collectively as “second distance data”. Hereinafter, an example when the second distance data are group-of-points data will be mainly described.

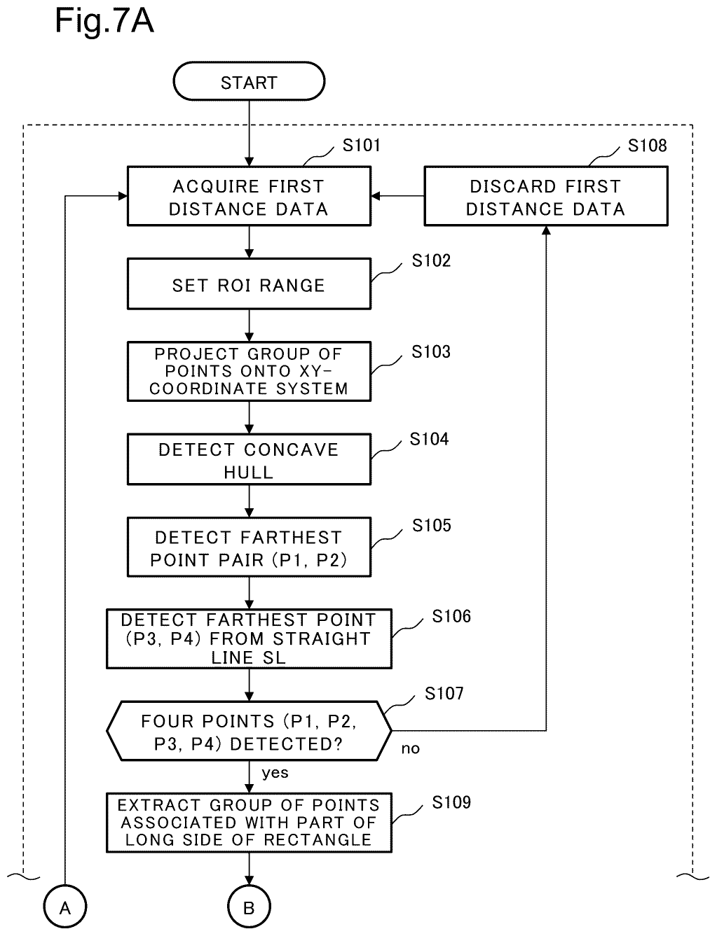

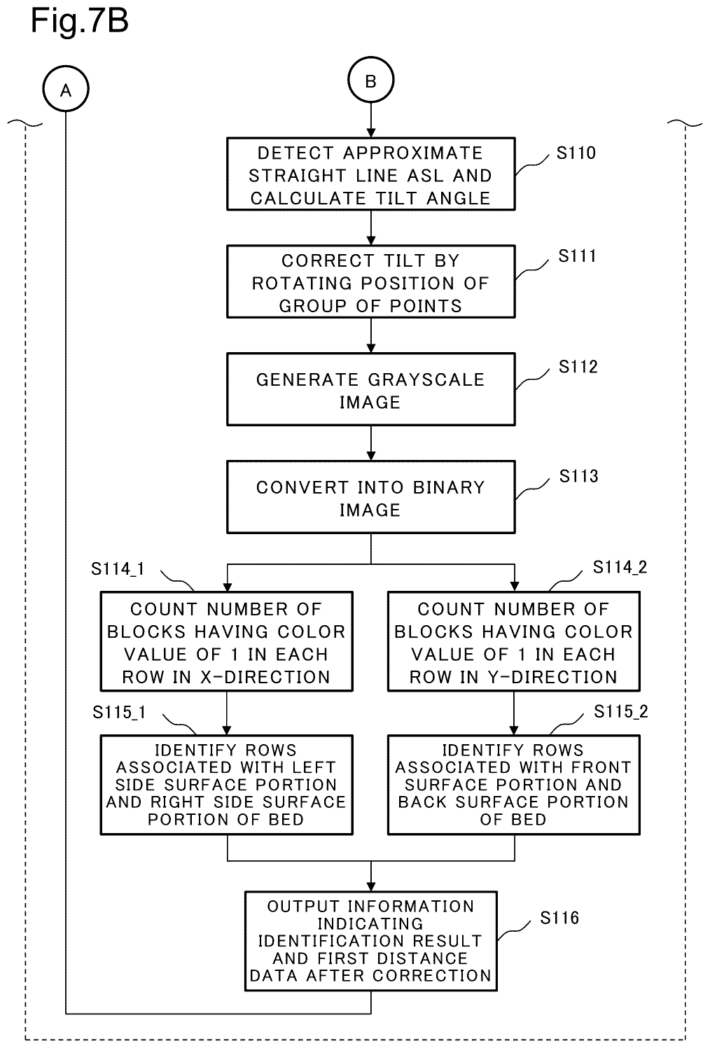

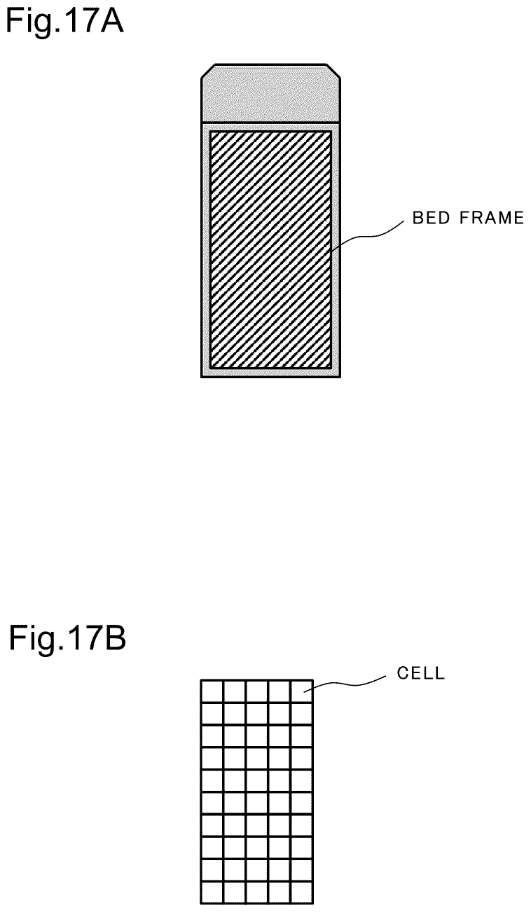

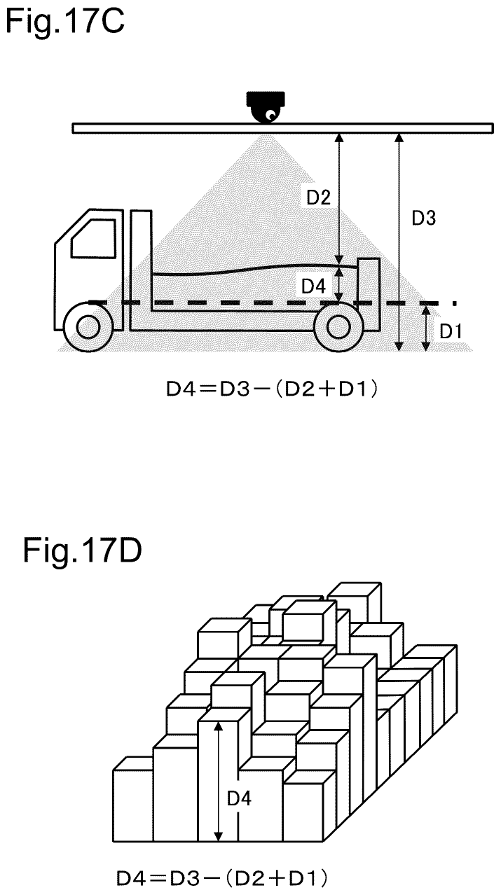

The first identifying unit 13 identifies a rectangular virtual frame (hereinafter, may be referred to as a “bed frame”. For example, see FIG. 17A) associated with a peripheral wall portion of the bed of the freight vehicle FV, by using the first distance data acquired by the first distance data acquisition unit 11. Note that, the bed frame may have a substantially rectangular shape (for example, a rectangular shape with chamfered corners). Further, when a stop direction of the freight vehicle FV is tilted relative to the above predetermined orientation, the first identifying unit 13 corrects the first distance data in such a way as to correct a tilt of the stop direction in processing of identifying the bed frame. The first identifying unit 13 outputs the first distance data after the correction to the volume measurement unit 15. Further, the first identifying unit 13 outputs information indicating a result of the identification (that is, information indicating a position and a size of the identified bed frame) to the volume measurement unit 15. A specific example of processing executed by the first identifying unit 13 will be described later with reference to FIGS. 7A to 12.

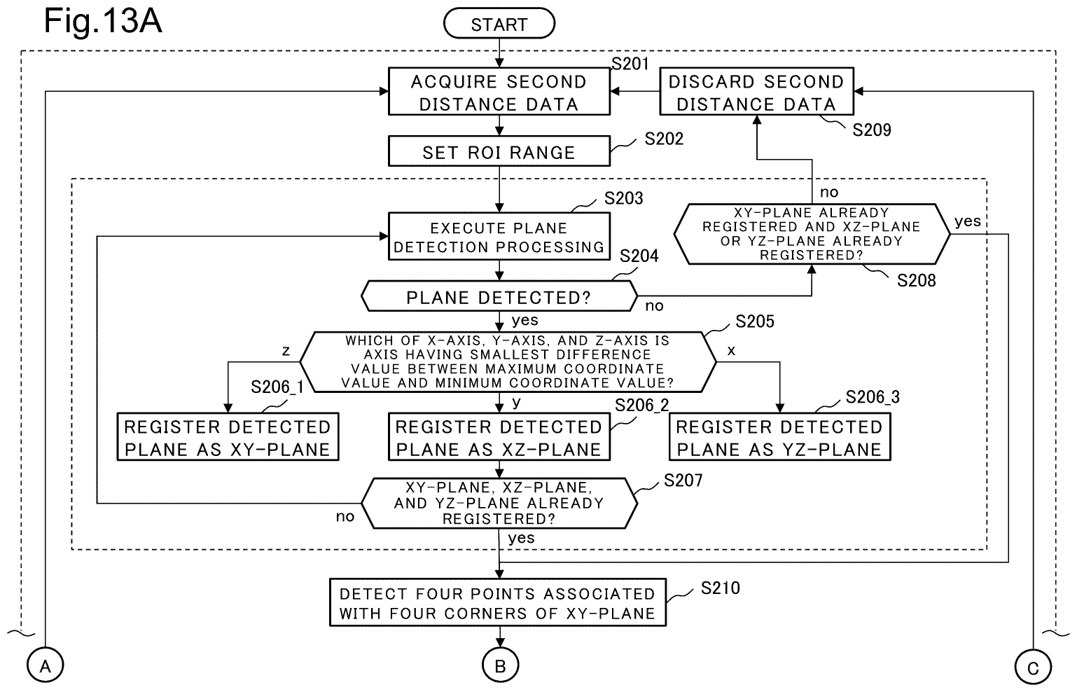

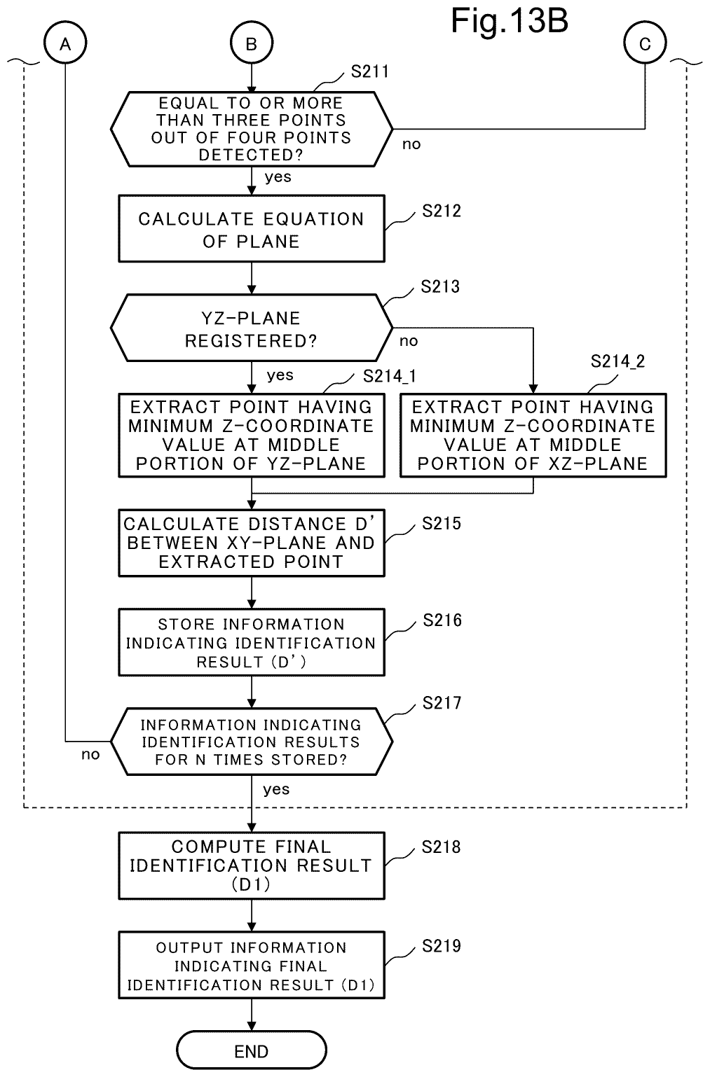

The second identifying unit 14 identifies a position of a bottom surface portion (more specifically, an inner bottom surface portion) of the bed of the freight vehicle relative to the ground surface, by using the second distance data acquired by the second distance data acquisition unit 12. In other words, the second identifying unit 14 identifies a position of the bottom surface portion in a height direction of the freight vehicle FV (that is, a distance from the ground surface to the bottom surface portion). Hereinafter, the position may be referred to as a “bottom surface height”. The second identifying unit 14 outputs information indicating a result of the identification (that is, information indicating the identified bottom surface height) to the volume measurement unit 15. A detail of processing executed by the second identifying unit 14 will be described later with reference to FIGS. 13A to 15.

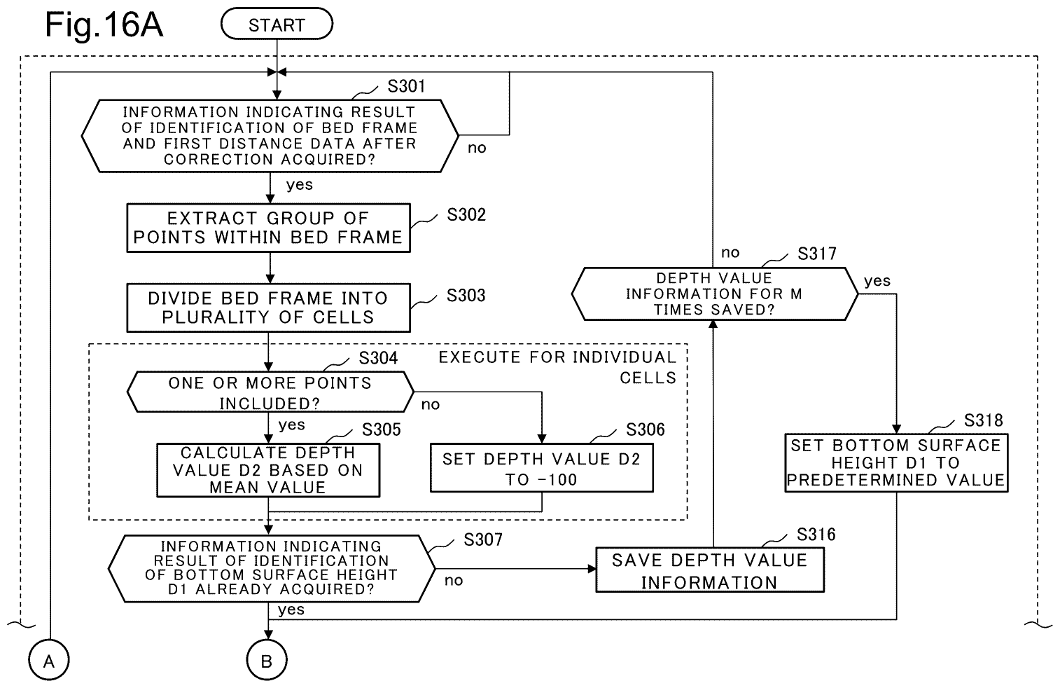

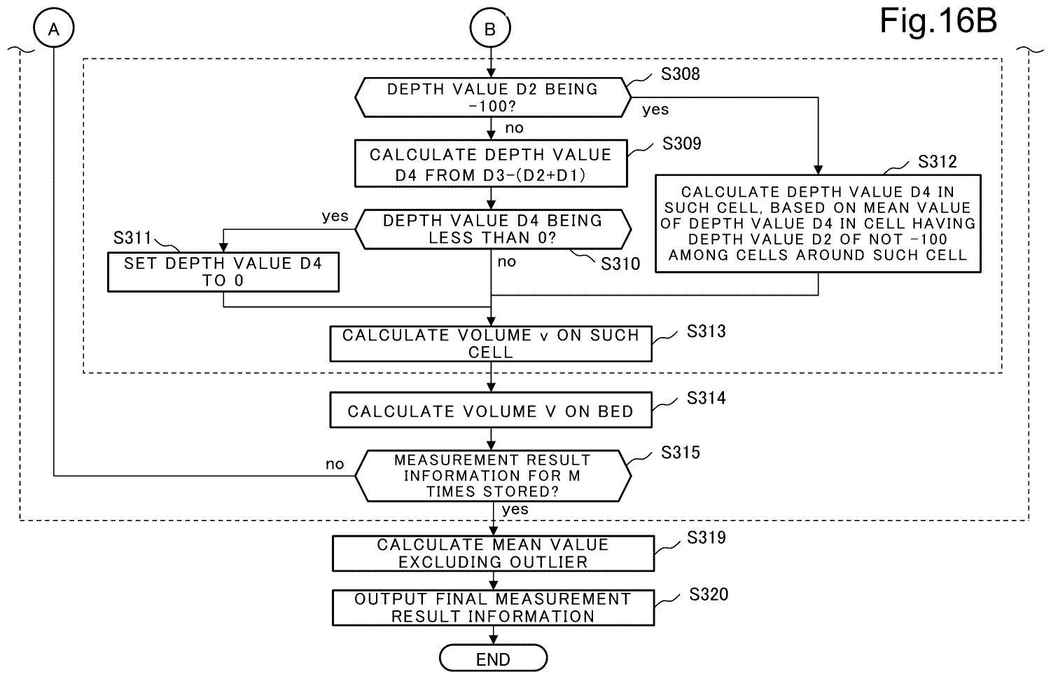

The volume measurement unit 15 measures a volume of the load on the bed of the freight vehicle FV by using the first distance data (that is, the first distance data after correction) output by the first identifying unit 13, based on a result of identification by the first identifying unit 13 and the second identifying unit 14. A detail of processing executed by the volume measurement unit 15 will be described later with reference to FIGS. 16A to 17D.

The output control unit 16 executes control of outputting information (hereinafter, may be referred to as “measurement result information”) indicating a result of measurement by the volume measurement unit 15. For outputting the measurement result information, the output device 4 is used. The output device 4 is configured by, for example, a display. In this case, the output control unit 16 executes control of causing the display to display an image (that is, an image including a result of measurement by the volume measurement unit 15) associated with the measurement result information. Thereby, a user (for example, a load assessor) of the volume measurement system 100 is able to visually recognize a result of measurement of a volume.

In this way, the main portion of the volume measurement system 100 is configured.

Note that, measurement of a distance using the first distance sensor 1 may be repeatedly executed in a state where the freight vehicle FV is stopped at a predetermined position and the bed of the freight vehicle FV is loaded with a load. The first distance data acquisition unit 11 may acquire the first distance data acquired by each time of measurement. In this case, the first identifying unit 13 may execute processing of identifying the bed frame by using the first distance data acquired by each time of measurement. Thereby, processing of identifying the bed frame is executed a plurality of times. Further, the volume measurement unit 15 may execute processing of measuring the volume, based on a result of each time of processing by the first identifying unit 13. That is, the volume measurement unit 15 may execute processing of measuring the volume by using the first distance data corrected by each time of correction by the first identifying unit 13. Thereby, processing of measuring the volume is executed a plurality of times. The volume measurement unit 15 may exclude an outlier in a result of the plurality of times of processing, as will be described later.

Further, measurement of a distance using the second distance sensor 2 may be repeatedly executed in a state where the freight vehicle FV is stopped at a predetermined position and the bed of the freight vehicle FV is loaded with a load. The second distance data acquisition unit 12 may acquire the second distance data acquired by each time of measurement. In this case, the second identifying unit 14 may execute processing of identifying the bottom surface height by using the second distance data acquired by each time of measurement. Thereby, processing of identifying the bottom surface height is executed a plurality of times. The second identifying unit 14 may exclude an outlier in a result of the plurality of times of processing, as will be described later.

Further, the second distance sensor 2 may be constituted of a plurality of distance sensors (for example, two distance sensors). In this case, the back surface portion of the bed and the ground surface may be irradiated with the second searching wave by one distance sensor out of the two second distance sensors, and the side surface portion of the bed and the ground surface may be irradiated with the second searching wave by another one second distance sensor out of the two distance sensors.

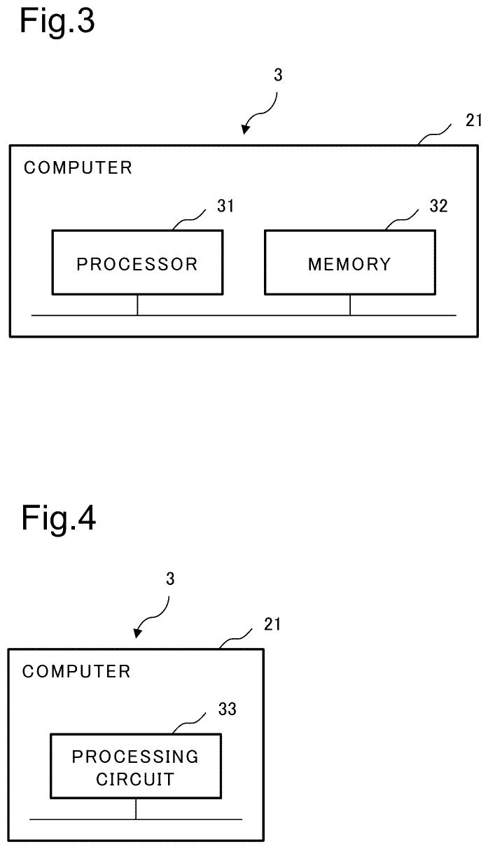

Next, a hardware configuration of a main portion of the volume measurement device 3 will be described with reference to FIGS. 3 to 5. As illustrated in each of FIGS. 3 to 5, the volume measurement device 3 uses a computer 21.

As illustrated in FIG. 3, the computer 21 includes a processor 31 and a memory 32. The memory 32 stores a program for causing the computer 21 to function as the first distance data acquisition unit 11, the second distance data acquisition unit 12, the first identifying unit 13, the second identifying unit 14, the volume measurement unit 15, and the output control unit 16. The processor 31 reads out and executes the program stored in the memory 32. Thereby, a function F1 of the first distance data acquisition unit 11, a function F2 of the second distance data acquisition unit 12, a function F3 of the first identifying unit 13, a function F4 of the second identifying unit 14, a function F5 of the volume measurement unit 15, and a function F6 of the output control unit 16 are achieved.

Alternatively, as illustrated in FIG. 4, the computer 21 includes a processing circuit 33. The processing circuit 33 executes processing for causing the computer 21 to function as the first distance data acquisition unit 11, the second distance data acquisition unit 12, the first identifying unit 13, the second identifying unit 14, the volume measurement unit 15, and the output control unit 16. Thereby, the functions F1 to F6 are achieved.

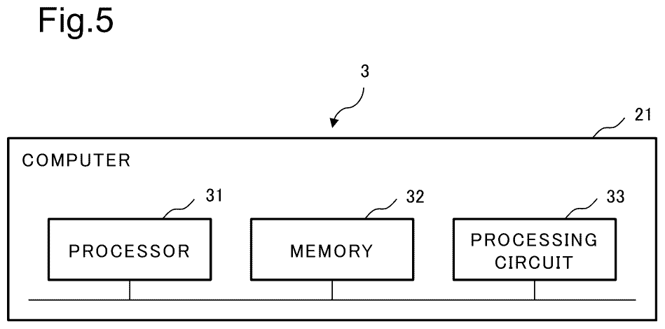

Alternatively, as illustrated in FIG. 5, the computer 21 includes the processor 31, the memory 32, and the processing circuit 33. In this case, some functions of the functions F1 to F6 are achieved by the processor 31 and the memory 32, and remaining functions of the functions F1 to F6 are achieved by the processing circuit 33.

The processor 31 is constituted of one or more processors. The individual processor uses, for example, a central processing unit (CPU), a graphics processing unit (GPU), a microprocessor, a microcontroller, or a digital signal processor (DSP).

The memory 32 is constituted of one or more memories. The individual memory uses, for example, a random access memory (RAM), a read only memory (ROM), a flash memory, an erasable programmable read only memory (EPROM), an electrically erasable programmable read only memory (EEPROM), a solid state drive, a hard disk drive, a flexible disk, a compact disc, a digital versatile disc (DVD), a Blu-ray disc, a magneto optical (MO) disc, or a MiniDisc.

The processing circuit 33 is constituted of one or more processing circuits. The individual processing circuit uses, for example, an application specific integrated circuit (ASIC), a programmable logic device (PLD), a field programmable gate array (FPGA), a system on a chip (SoC), or a system large scale integration (LSI).

Note that, the processor 31 may include a dedicated processor associated with each of the functions F1 to F6. The memory 32 may include a dedicated memory associated with each of the functions F1 to F6. The processing circuit 33 may include a dedicated processing circuit associated with each of the functions F1 to F6.

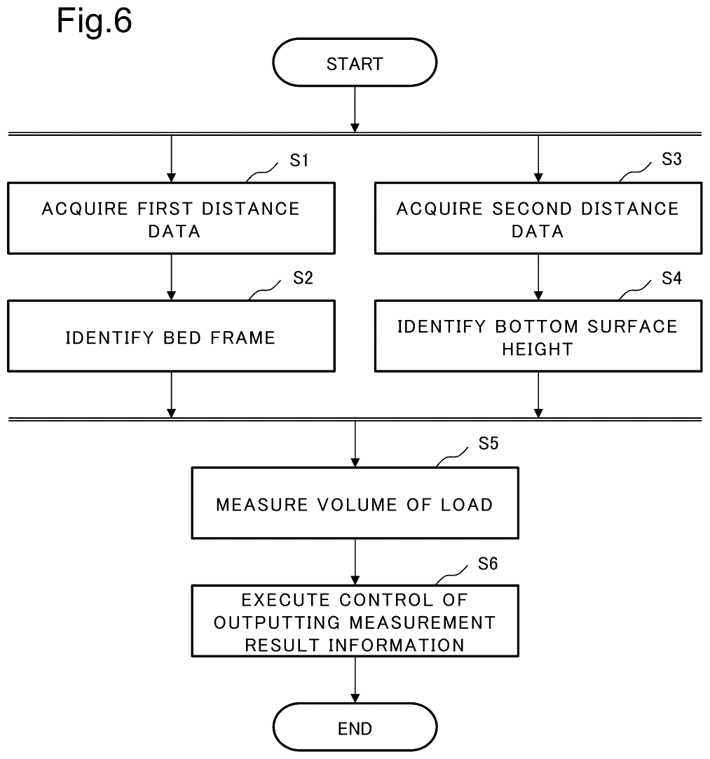

Next, an operation of the volume measurement device 3 will be described with reference to a flowchart illustrated in FIG. 6.

First, the first distance data acquisition unit 11 acquires first distance data (Step S1). Then, the first identifying unit 13 identifies a bed frame (Step S2). At this time, the first identifying unit 13 corrects the first distance data in such a way as to correct a tilt of a stop direction of a freight vehicle FV. Further, the second distance data acquisition unit 12 acquires second distance data (Step S3). Then, the second identifying unit 14 identifies a bottom surface height (Step S4).

Herein, the processing in Steps S1 and S2 and the processing in Steps S3 and S4 are executed in any order. That is, the processing in Steps S1 and S2 may be executed, followed by the processing in Steps S3 and S4. Alternatively, the processing in Steps S3 and S4 may be executed, followed by the processing in Steps S1 and S2. Alternatively, the processing in Steps S1 and S2 and the processing in Steps S3 and S4 may be executed in parallel to each other.

Then, the volume measurement unit 15 measures a volume of a load on a bed of the freight vehicle FV, based on a result of identification in Steps S2 and S4. Then, the output control unit 16 executes control of outputting information (that is, measurement result information) indicating a result of measurement in Step S5 (Step S6).

Next, a detail of processing executed by the first identifying unit 13 will be described with reference to FIGS. 7A to 12. That is, a specific example of a method of identifying a bed frame will be described.

FIGS. 7A and 7B are flowcharts illustrating a detailed operation of the first distance data acquisition unit 11 and the first identifying unit 13. Step S101 in FIG. 7A is associated with Step S1 in FIG. 6. Steps S102 to S116 in FIGS. 7A and 7B are associated with Step S2 in FIG. 6.

First, the first distance data acquisition unit 11 acquires first distance data (Step S101). Specifically, for example, the first distance data acquisition unit 11 acquires first distance data acquired by first-time measurement using the first distance sensor 1.

Then, the first identifying unit 13 sets a predetermined region of interest (ROI) range (Step S102). This is intended to exclude a group of points (for example, a group of points associated with the ground surface) that are not used in identification of a bed frame among a group of points included in the first distance data.

Then, the first identifying unit 13 projects a group of points within the ROI range among the group of points included in the first distance data onto an XY-coordinate system (Step S103). Herein, the XY-coordinate system is a coordinate system parallel to a horizontal plane. An X-axis in the XY-coordinate system is a virtual axis associated with a front-back direction (X-direction) of the freight vehicle FV in a state where the freight vehicle FV is stopped at the above predetermined position in the above predetermined orientation. A Y-axis in the XY-coordinate system is a virtual axis associated with a left-right direction (Y-direction) of the freight vehicle FV in a state where the freight vehicle FV is stopped at the above predetermined position in the above predetermined orientation.

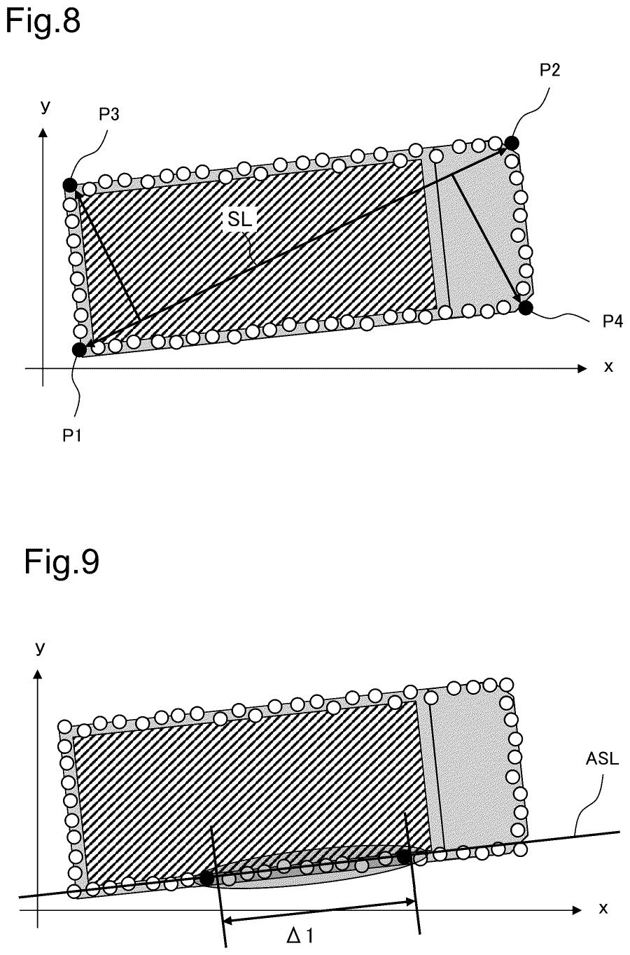

Then, the first identifying unit 13 detects a concave hull including the projected group of points (S104). The first identifying unit 13 detects a farthest point pair of vertices of the detected concave hull (Step S105. See P1 and P2 in FIG. 8). The first identifying unit 13 finds, for each of two directions perpendicular to a straight line (see SL in FIG. 8) connecting between the detected farthest point pair, a farthest point from the straight line (Step S106. See P3 and P4 in FIG. 8).

When the four points are normally detected (Step S107 “YES”), the first identifying unit 13 determines that the four points (P1, P2, P3, P4) are associated with four corners of the bed. In this case, the processing of the first identifying unit 13 proceeds to Step S109.

Meanwhile, for example, when the first distance data acquired in Step S101 do not include the four points (P1, P2, P3, P4), the four points (P1, P2, P3, P4) are not normally detected. In such a case (Step S107 “NO”), the first identifying unit 13 discards the acquired first distance data (Step S108). The processing of the volume measurement device 3 returns to Step S101. The first distance data acquisition unit 11 acquires first distance data acquired by next-time measurement using the first distance sensor 1.

In Step S109, the first identifying unit 13 extracts, based on a result of determination on the four corners, a group of points associated with at least a part of a left side surface portion or a right side surface portion of the bed among the above projected group of points. Specifically, for example, the first identifying unit 13 extracts a group of points associated with a one-third part (see Δ1 in FIG. 9) at a middle of a long side of a rectangle based on the four corners.

Then, the first identifying unit 13 detects, based on a coordinate value (more specifically, an X-coordinate value and a Y-coordinate value) of the above extracted individual points, an approximate straight line (see ASL in FIG. 9) associated with the left side surface portion or the right side surface portion of the bed (that is, a left side surface portion or a right side surface portion of the freight vehicle FV). The first identifying unit 13 calculates a tilt angle of the approximate straight line ASL relative to the X-axis (Step S110).

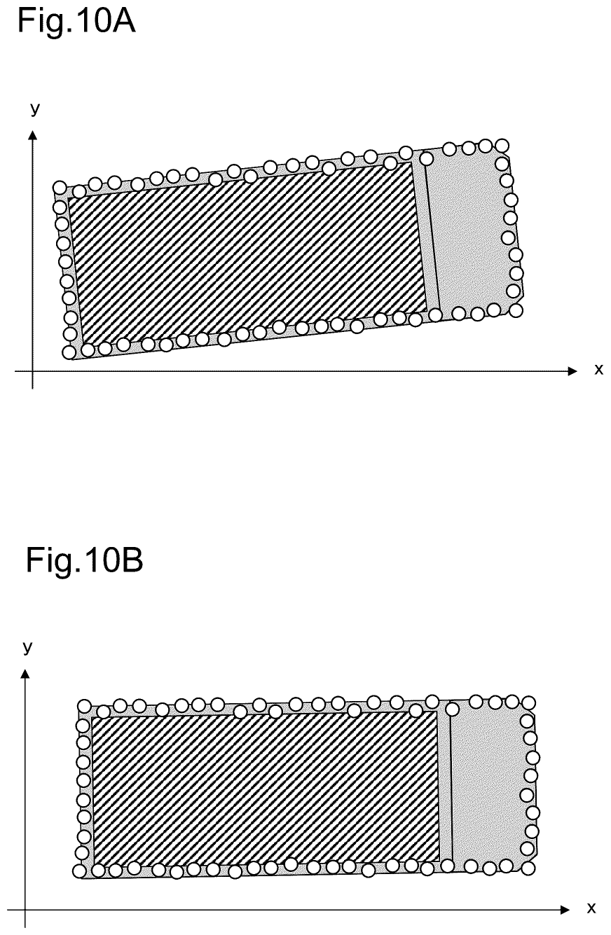

Then, the first identifying unit 13 rotates, for the group of points included in the first distance data, a position of the group of points in the XY-coordinate system in such a way that the tilt angle becomes 0. Thereby, the first distance data are corrected in such a way as to correct a tile of a stop direction (Step S111). FIG. 10A illustrates an example of a group of points before correction. In contrast thereto, FIG. 10B illustrates an example of a group of points after correction.

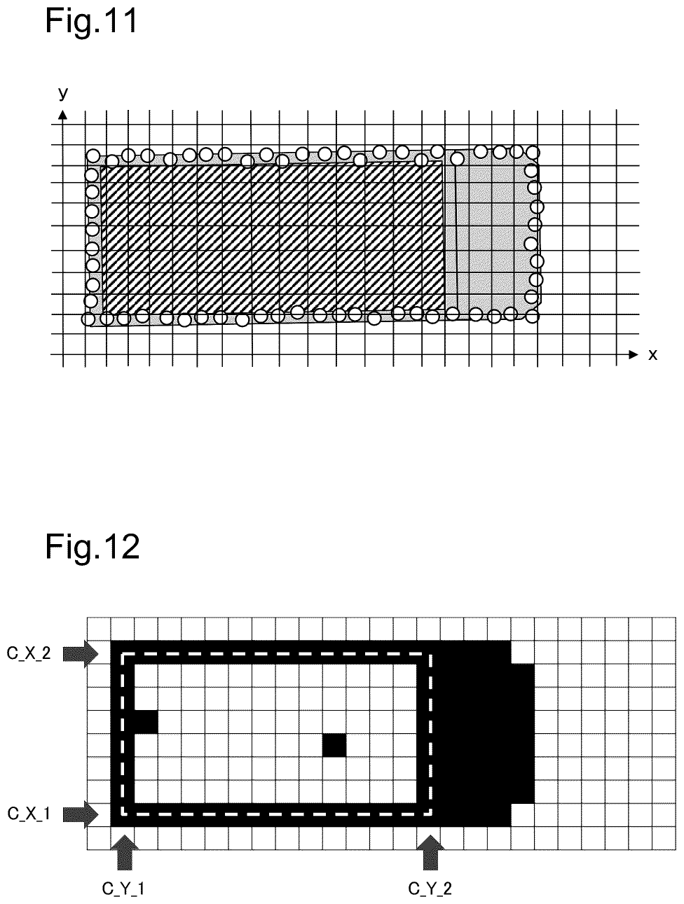

Then, the first identifying unit 13 divides the XY-coordinate system into predetermined intervals (for example, 5-centimeter intervals) in the X-direction and the Y-direction, thereby setting a plurality of blocks (see FIG. 11). The first identifying unit 13 generates, based on a Z-coordinate value (that is, a coordinate value for a height direction) of a point included in an individual block, a grayscale image associated with the XY-coordinate system (Step S112). For example, for a certain block, when the Z-coordinate value of a point included in the block is a predetermined highest value, a color value of the block is set to 255 among 256 shades of gray (0 to 255). Further, for example, when the Z-coordinate value of a point included in the block is a predetermined minimum value, a color value of the block is set to 0 among 256 shades of gray (0 to 255).

Then, the first identifying unit 13 compares the color value of the individual block with a predetermined threshold value, thereby converting the generated grayscale image into a black and white binary image (Step S113). For example, when a color value of a certain block is equal to or more than the threshold value, the first identifying unit 13 converts the color value of the block into 1 (black). Meanwhile, when a color value of a certain block is less than the threshold value, the first identifying unit 13 converts the color value of the block into 0 (white). The threshold value is set to, for example, a value of “200” among color values (0 to 255) of 256 shades of gray.

Then, the first identifying unit 13 counts the number of blocks having a color value of 1 in each row along the X-direction among the plurality of blocks (Step S114_1). The first identifying unit 13 detects two rows (see C_X_1 and C_X_2 in FIG. 12) among rows having the number larger than the number in other rows. Thereby, the first identifying unit 13 identifies a row (C_X_2) associated with the left side surface portion of the bed and a row (C_X_1) associated with the right side surface portion of the bed (Step S115_1).

Similarly, the first identifying unit 13 counts the number of blocks having a color value of 1 in each row along the Y-direction among the plurality of blocks (Step S114_2). The first identifying unit 13 detects two rows (see C_Y_1 and C_Y_2 in FIG. 12) among rows having the number larger than the number in other rows. Thereby, the first identifying unit 13 identifies a row (C_Y_2) associated with a front surface portion of the bed and a row (C_Y_1) associated with a back surface portion of the bed (Step S115_2).

That is, a row associated with each long side of the rectangular bed frame (see dashed lines in FIG. 12) is identified by the processing in Step S115_1 in FIG. 6. Further, a row associated with each short side of the rectangular bed frame (see dashed lines in FIG. 12) is identified by the processing in Step S115_2. In this way, four connected dashed lines in FIG. 12 is identified as the bed frame.

Then, the first identifying unit 13 outputs, to the volume measurement unit 15, information indicating a result of the identification and the first distance data after correction (Step S116). Then, the processing of the volume measurement device 3 returns to Step S101. The first distance data acquisition unit 11 acquires first distance data acquired by next-time measurement using the first distance sensor 1 (Step S101).

In this way, processing of identifying the bed frame is executed by using the first distance data acquired by each time of measurement, as described above. Further, the first distance data are corrected in each time of processing in such a way as to correct a tilt of a stop direction of the freight vehicle FV.

Next, a detail of processing executed by the second identifying unit 14 will be described with reference to FIGS. 13A to 15. That is, a specific example of a method of identifying a bottom surface height will be described.

FIGS. 13A and 13B are flowcharts illustrating a detailed operation of the second distance data acquisition unit 12 and the second identifying unit 14. Step S201 in FIG. 13A is associated with Step S3 in FIG. 6. Steps S202 to S219 in FIGS. 13A and 13B are associated with Step S4 in FIG. 6.

First, the second distance data acquisition unit 12 acquires second distance data (Step S201). Specifically, for example, the second distance data acquisition unit 12 acquires second distance data acquired by first-time measurement using the second distance sensor 2.

Then, the second identifying unit 14 sets a predetermined ROI range (Step S202). This is intended to exclude a group of points (for example, a group of points associated with another object different from the freight vehicle FV) that are not used in identification of a bottom surface height among a group of points included in the second distance data.

Then, the second identifying unit 14 executes plane detection processing for a group of points within the ROI range among the group of points included in the second distance data (Step S203). The plane detection processing is for detecting a largest plane in a target group of points.

When a plane is detected by the plane detection processing (Step S204 “YES”), the second identifying unit 14 calculates, for a group of points included in the detected plane, a difference value between a maximum value and a minimum value for an X-coordinate value. Further, the second identifying unit 14 calculates, for the group of points, a difference value between a maximum value and a minimum value for a Y-coordinate value. Further, the second identifying unit 14 calculates, for the group of points, a difference value between a maximum value and a minimum value for a Z-coordinate value. The second identifying unit 14 determines which of an X-axis, a Y-axis, and a Z-axis is an axis having the smallest calculated difference value (Step S205).

When a determination result in Step S205 is a Z-axis, the second identifying unit 14 determines that the above detected plane is an XY-plane. The second identifying unit 14 registers the above detected plane as an XY-plane (Step S206_1). Further, the second identifying unit 14 excludes a group of points included in the registered plane from a target for subsequent plane detection processing. However, when the XY-plane is already registered, the processing in Step S206_1 is skipped.

When a determination result in Step S205 is a Y-axis, the second identifying unit 14 determines that the above detected plane is an XZ-plane. The second identifying unit 14 registers the above detected plane as an XZ-plane (Step S206_2). Further, the second identifying unit 14 excludes a group of points included in the registered plane from a target for subsequent plane detection processing. However, when the XZ-plane is already registered, the processing in Step S206_2 is skipped.

When a determination result in Step S205 is an X-axis, the second identifying unit 14 determines that the above detected plane is a YZ-plane. The second identifying unit 14 registers the above detected plane as a YZ-plane (Step S206_3). Further, the second identifying unit 14 excludes a group of points included in the registered plane from a target for subsequent plane detection processing. However, when the YZ-plane is already registered, the processing in Step S206_3 is skipped.

Then, the second identifying unit 14 determines whether the XY-plane, the XZ-plane, and the YZ-plane are already registered (Step S207). When all of the XY-plane, the XZ-plane, and the YZ-plane are already registered (Step S207 “YES”), the processing of the volume measurement device 3 proceeds to Step S210. Meanwhile, when at least one of the XY-plane, the XZ-plane, and the YZ-plane is unregistered (Step S207 “NO”), the processing of the volume measurement device 3 returns to Step S203. Thereby, the plane detection processing is executed.

Note that, when no plane is detected by the plane detection processing (Step S204 “NO”), the processing of the volume measurement device 3 proceeds to Step S208. In Step S208, the second identifying unit 14 determines whether the XY-plane is already registered and the XZ-plane or the XZ-plane is already registered. When the XY-plane is unregistered, or when the XY-plane is already registered but both of the XZ-plane and the YZ-plane are unregistered (Step S208 “NO”), the second identifying unit 14 discards the above acquired second distance data (Step S209). The processing of the volume measurement device 3 returns to Step S201. The second distance data acquisition unit 12 acquires second distance data acquired by next-time measurement using the second distance sensor 2.

Meanwhile, when the XY-plane is already registered and the XZ-plane or the XZ-plane is already registered (Step S208 “YES”), the processing of the volume measurement device 3 proceeds to Step S210.

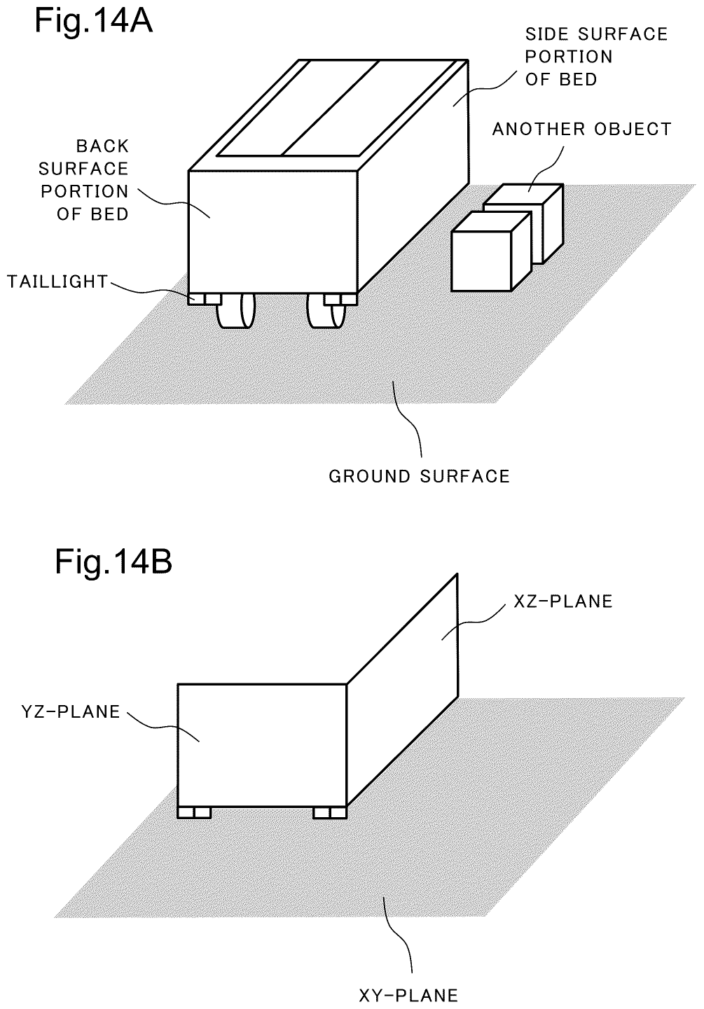

That is, when the processing of the volume measurement device 3 proceeds to Step S210, the XY-plane is already registered and at least one of the XZ-plane and the YZ-plane is already registered in the second identifying unit 14. As illustrated in FIGS. 14A and 14B, it is highly probable that the registered XY-plane is a plane associated with the ground surface around the freight vehicle FX. Further, it is highly probable that the registered XZ-plane is a plane associated with the side surface portion (for example, the right side surface portion) of the bed of the freight vehicle FV. Further, it is highly probable that the registered YZ-plane is a plane associated with a back surface portion of the bed of the freight vehicle FV.

In Step S210, the second identifying unit 14 detects a coordinate value of four points associated with four corners of the above registered XY-plane. That is, the second identifying unit 14 detects an X-coordinate value, a Y-coordinate value, and a Z-coordinate value of each of the four points.

When a coordinate value of any one or two points out of the four points is detected (Step S211 “NO”), the processing of the volume measurement device 3 proceeds to Step S209. Meanwhile, when a coordinate value of at least three points out of the four points is detected (Step S211 “YES”), the second identifying unit 14 calculates, for the XY-plane, a so-called “equation of a plane” by using the coordinate value thereof (Step S212). That is, the second identifying unit 14 calculates individual variables (a, b, c, d) in the equation of a plane (ax+by+cz+d=0).

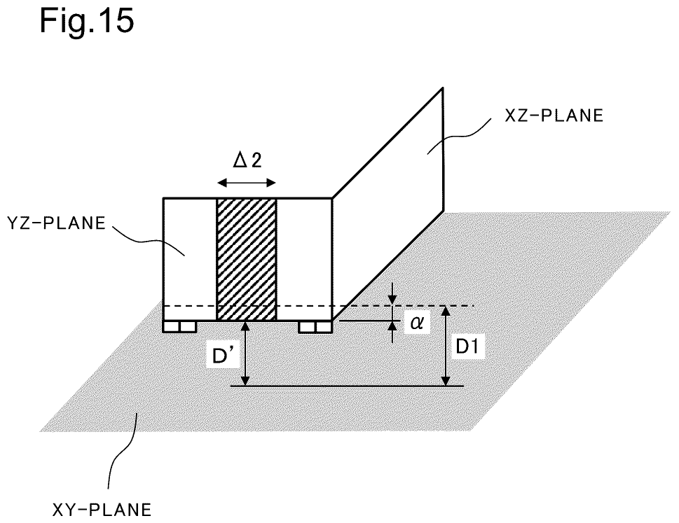

Then, the second identifying unit 14 determines whether the YZ-plane is registered (Step S213). When the YZ-plane is registered (Step S213 “YES”), the second identifying unit 14 detects a point having a minimum Z-coordinate value for a predetermined range (see Δ2 illustrated in FIG. 15) being a middle portion in the Y-direction of the YZ-plane (Step S214_1). The range (Δ2) is set to, for example, a range of ±10 centimeters from a center portion in the Y-direction of the YZ-plane.

The coordinate value of the detected point is used in identification of a bottom surface height in Step S215 to be described later. Herein, as illustrated in FIGS. 14A and 14B, it is possible that the YZ-plane may include a part associated with a taillight of the freight vehicle FV. Thus, supposing that a point indicating a minimum Z-coordinate value on the YZ-plane is detected without setting the range (42) as described above, it is possible that a position of the taillight in a height direction (Z-direction) may be identified, instead of a bottom surface height being identified. That is, it is possible that a bottom surface height may not be accurately identified. In contrast thereto, the problem can be prevented from occurring by setting the range (42) as described above.

Note that, when the YZ-plane is not registered (Step S213 “NO”), the second identifying unit 14 executes processing similar to Step S214_1 for the XZ-plane (Step S214_2). That is, the second identifying unit 14 detects a point having a minimum Z-coordinate value for a predetermined range being a middle portion in the X-direction of the XZ-plane.

Then, the second identifying unit 14 calculates a distance (see D′ in FIG. 15) between the plane and the point, based on the equation calculated in Step S212 and the coordinate value of the point detected in Step S214_1 or S214_2 (Step S215). It is highly probable that the distance D′ is associated with a position of a bottom surface portion (more specifically, an outer bottom surface portion) of the bed relative to the ground surface. In other words, the second identifying unit 14 identifies a bottom surface height by calculating the distance D′.

Then, the second identifying unit 14 stores information indicating a result of the identification (that is, information indicating the calculated distance D′) (Step S216).

Then, the second identifying unit 14 determines whether information indicating identification results for N times (for example, for twelve times) is stored (Step S217). When information indicating identification results for N times is stored (Step S217 “YES”), the processing of the volume measurement device 3 proceeds to Step S218. When not stored (Step S217 “NO”), the processing of the volume measurement device 3 returns to Step S201.

When information indicating identification results for N times is stored (Step S217 “YES”), the second identifying unit 14 computes a final identification result, based on the identification results (Step S218).

That is, the identification results include N (for example, twelve) distances D′. First, the second identifying unit 14 executes statistical processing on the values (D′), thereby excluding an outlier in the values (D′) and calculating a mean value of remaining values (D′). The statistical processing uses, for example, a so-called “box-and-whisker plot”. Then, the second identifying unit 14 adds, to the calculated mean value, a predetermined value (see α in FIG. 15. For example, 15 centimeters) associated with a thickness of the bottom surface portion of the bed. The second identifying unit 14 uses a value (D1) after the addition for a final identification result.

Then, the second identifying unit 14 outputs information indicating the final identification result (D1) to the volume measurement unit 15 (Step S219).

Next, a detail of processing executed by the volume measurement unit 15 will be described with reference to FIGS. 16A to 17D. That is, a specific example of a method of measuring a volume will be described.

FIGS. 16A and 16B are flowcharts illustrating a detailed operation of the volume measurement unit 15 and the output control unit 16. Steps S301 to S319 in FIGS. 16A and 16B are associated with Step S5 in FIG. 6. Step S320 in FIG. 16B is associated with Step S6 in FIG. 6.

As described above, the first identifying unit 13 outputs, to the volume measurement unit 15, information indicating a result of identification of the bed frame and the first distance data after correction (Step S116 in FIG. 7B). When the information and the data are acquired (Step S301 “YES”), the volume measurement unit 15 extracts a group of points positioned within the bed frame among a group of points included in the acquired first distance data (Step S302).

Then, the volume measurement unit 15 divides the bed frame into predetermined intervals in the X-direction and the Y-direction, thereby setting a plurality of rectangular cells. In other words, the volume measurement unit 15 divides the bed frame into a plurality of cells (Step S303). For example, as illustrated in FIGS. 17A and 17B, the volume measurement unit 15 equally divides the bed frame into ten in the X-direction (front-back direction of the freight vehicle FV), and equally divides the bed frame into five in the Y-direction (left-right direction of the freight vehicle FV). Thereby, fifty cells are set.

Hereinafter, a value (including a Z-coordinate value of an individual point) indicating a distance, a position, a height, or the like in the Z-direction may be referred to collectively as a “depth value”. The depth value uses, for example, a unit of meter.

Then, the volume measurement unit 15 executes following processing of Steps S304 and S305 for individual cells. That is, when the cell includes one or more points (Step S304 “YES”), the volume measurement unit 15 calculates a mean value of the Z-coordinate values (that is, the depth values) of the points, thereby calculating a depth value D2 of the cell. Meanwhile, when the cell does not include any point (Step S304 “NO”), the volume measurement unit 15 sets the depth value D2 of the cell to a predetermined value (for example, −100) (Step S306).

As described above, the second identifying unit 14 outputs, to the volume measurement unit 15, information indicating an identification result (more specifically, information indicating a final identification result) of the bottom surface height D1 (Step S219 in FIG. 13B). When the information is already acquired (Step S307 “YES”), the volume measurement unit 15 executes following processing of Steps S308 to S313 for individual cells.

That is, when the depth value D2 of the cell is not set to −100 (Step S308 “NO”), the volume measurement unit 15 calculates a depth value D4 associated with bulkiness of a load on the cell by using a following equation (1) (Step S309).

$$D 4 = D 3 - ( D 2 + D 1 ) \qquad ( 1 )$$

Herein, D3 is a depth value associated with an installation height of the first distance sensor 1 (see FIG. 17C). Information indicating the depth value D3 may be stored in advance in the volume measurement device 3. Alternatively, when the ground surface is irradiated by the first distance sensor 1 with the searching wave, a group of points associated with the ground surface is also included in the first distance data. The depth value D3 may be calculated by the volume measurement device 3, based on the group of points. As illustrated in FIGS. 17C and 17D, the depth value D4 to be calculated by using the above equation (1) is associated with bulkiness of a load on the cell. However, when the calculated depth value D4 is a value less than 0 (that is, a negative value) (Step S310 “YES”), the volume measurement unit 15 sets the depth value D4 of the cell to 0.

Further, when the depth value D2 of the cell is set to −100 (Step S308 “YES”), the volume measurement unit 15 detects a cell having the depth value D2 not set to −100, among cells around the cell. The volume measurement unit 15 calculates a mean value of the depth values D4 of the detected cells. The volume measurement unit 15 uses the calculated mean value for the depth value D4 of the cell (Step S312).

For example, it is assumed that the depth value D2 of two cells adjacent to the cell in the X-direction is not set to −100, and the depth value D2 of two cells adjacent to the cell in the Y-direction is not set to −100. In this case, a mean value of the depth values D4 of the four cells is used for the depth value D4 of the cell.

Alternatively, for example, it is assumed that the depth value D2 of two cells adjacent to the cell in the X-direction is not set to −100, but the depth value D2 of at least one cell out of two cells adjacent to the cell in the Y-direction is set to −100. In this case, a mean value of the depth values D4 of the two cells adjacent to the cell in the X-direction is used for the depth value D4 of the cell.

Alternatively, for example, it is assumed that the depth value D2 of two cells adjacent to the cell in the Y-direction is not set to −100, but the depth value D2 of at least one cell out of two cells adjacent to the cell in the X-direction is set to −100. In this case, a mean value of the depth values D4 of the two cells adjacent to the cell in the Y-direction is used for the depth value D4 of the cell.

Then, the volume measurement unit 15 calculates a volume v of a load on the cell by using a following equation (2) (Step S313). Herein, A indicates an area of an individual cell.

$$v = A \times D 4 \qquad ( 2 )$$

Then, the volume measurement unit 15 calculates a total value of the volumes v of all cells, thereby calculating a volume V of a load on the bed (Step S314). The volume measurement unit 15 saves information (that is, measurement result information) indicating the calculated volume V. The volume measurement unit 15 repeatedly executes the processing until the volume V is calculated M times (for example, twelve times) (Step S315 “NO”). When the volume V is calculated M times (Step S315 “YES”), the processing of the volume measurement device 3 proceeds to Step S319.

Note that, when information indicating a result of identification of the bottom surface height D1 is unacquired (Step S307 “NO”), the volume measurement unit 15 saves information (hereinafter, referred to as “depth value information”) indicating the calculated or set depth value D2 (that is, the depth value D2 of an individual cell).

Then, the volume measurement unit 15 determines whether the depth value information for M times (for example, for twelve times) is saved (Step S317). When the depth value information for less than M times is saved (Step S317 “NO”), the processing of the volume measurement device 3 returns to Step S301. That is, when information indicating a result of next-time identification of the bed frame and first distance data after next-time correction are acquired (Step S301 “YES”), the processing in Step S302 and thereafter is executed.

Meanwhile, when the depth value information for M times is already saved (Step S317 “YES”), the volume measurement unit 15 sets the bottom surface height D1 to a predetermined value. Hereinafter, the processing in Steps S308 to 314 is executed by using the depth value D2 indicated by the depth value information in each time, in a state where the bottom surface height D1 is set to a predetermined value. That is, the processing is executed M times. Then, determination is made as “YES” in Step S315.

That is, when “YES” in Step S315, the volumes V for M times are already calculated. The volume measurement unit 15 executes statistical processing on the values (V), thereby excluding an outlier in the values (V) and calculating a mean value of remaining values (V) (Step S319). The statistical processing uses, for example, a box-and-whisker plot. The volume measurement unit 15 uses the mean value for a final measurement result.

Then, the output control unit 16 executes control of outputting information (that is, measurement result information) indicating a final measurement result in Step S319 (Step S320). Specifically, for example, the output control unit 16 executes control of displaying an image associated with the measurement result information (that is, an image including the mean value calculated in Step S319).

Next, an advantageous effect of using the volume measurement system 100 will be described.

As described above, in the volume measurement device 3, the first distance data acquisition unit 11 acquires first distance data acquired by the first distance sensor 1 that irradiates a bed of a freight vehicle FV with a first searching wave from above. The second distance data acquisition unit 12 acquires second distance data acquired by the second distance sensor 2 that irradiates at least one of a back surface portion and a side surface portion of the bed and a ground surface around the freight vehicle FV with a second searching wave. The first identifying unit 13 identifies a frame (bed frame) associated with a peripheral wall portion of the bed by using the first distance data. The second identifying unit 14 identifies a position (bottom surface height D1) of a bottom surface portion of the bed relative to the ground surface by using the second distance data. The volume measurement unit 15 measures a volume V of a load on the bed by using the first distance data, based on a result of identification by the first identifying unit 13 and the second identifying unit 14.

At this time, need for measurement by the distance sensor (the first distance sensor 1 and the second distance sensor 2) in an unloaded state can be eliminated by identifying the bottom surface height D1 by using the second distance data, upon measuring the volume V. Thereby, time to be taken for measurement of the volume V can be shortened. Further, even when measurement in an unloaded state cannot be performed (for example, when an agreement of a driver of the freight vehicle FV cannot be acquired), the volume V can be measured. Further, need for preliminarily preparing data indicating the bottom surface height D1 for each type of the freight vehicle FV can be also eliminated.

Further, when a stop direction of the freight vehicle FV is tilted relative to a predetermined orientation, the first identifying unit 13 corrects the first distance data in such a way as to correct a tilt of a stop position in processing of identifying the frame (bed frame). The volume measurement unit 15 uses the first distance data after correction in measurement of the volume V. Thereby, even when a stop direction of the freight vehicle FV is tilted relative to a predetermined orientation, the bed frame can be accurately identified. That is, the tilt can be prevented from affecting measurement of the volume V. As a result, the volume V can be accurately measured.

Further, the first distance data acquisition unit 11 acquires the first distance data acquired by a plurality of times of measurement using the first distance sensor 1. The first identifying unit 13 executes processing of identifying the frame (bed frame) by using the first distance data associated with each time of measurement, and thereby executes processing of identifying the frame (bed frame) a plurality of times. The volume measurement unit 15 measures the volume V, based on a result of each time of identification by the first identifying unit 13, thereby executes processing of measuring the volume V a plurality of times, and excludes an outlier in a result of the plurality of times of processing. Thereby, an error in measurement of the volume V due to variation of the first distance data can be prevented from occurring. As a result, the volume V can be accurately measured.

Further, the second distance data acquisition unit 12 acquires the second distance data acquired by a plurality of times of measurement using the second distance sensor 2. The second identifying unit 14 executes processing of identifying a position (bottom surface height) of the bottom surface portion by using the second distance data associated with each time of measurement, thereby executes processing of identifying a position (bottom surface height) of the bottom surface portion a plurality of times, and excludes an outlier in a result of the plurality of times of processing. Thereby, an error in identification of the bottom surface height due to variation of the second distance data can be prevented from occurring. As a result, the volume (V) can be accurately measured by accurately identifying the bottom surface height.

Further, the output control unit 16 executes control of outputting information (measurement result information) indicating a result of measurement by the volume measurement unit 15. Thereby, a user (for example, a load assessor) of the volume measurement system 100 can be informed of a result of measurement of the volume.

Further, each of the first distance sensor 1 and the second distance sensor 2 uses 3D-LiDAR, and each of the first searching wave and the second searching wave is laser light. Thereby, the volume measurement system 100 can be achieved by using 3D-LiDAR. [Second Example Embodiment]

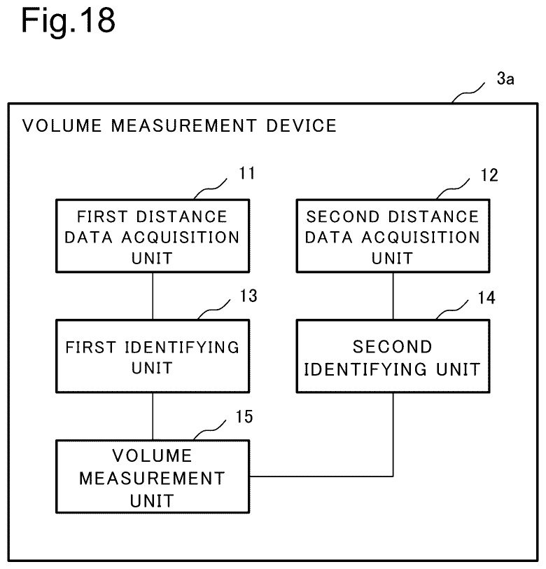

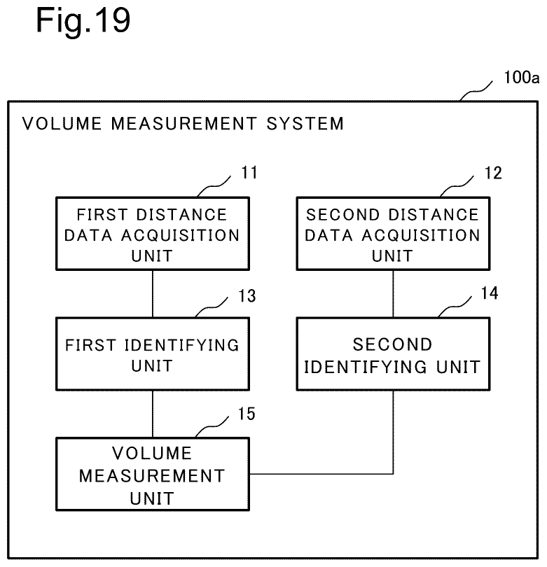

FIG. 18 is a block diagram illustrating a main portion of a volume measurement device according to a second example embodiment. The volume measurement device according to the second example embodiment will be described with reference to FIG. 18. Herein, the volume measurement device according to the above-described first example embodiment is one example of the volume measurement device according to the second example embodiment. Further, FIG. 19 is a block diagram illustrating a main portion of a volume measurement system according to the second example embodiment. The volume measurement system according to the second example embodiment will be described with reference to FIG. 19. Herein, the volume measurement system according to the above-described first example embodiment is one example of the volume measurement system according to the second example embodiment. Note that, in each of FIGS. 18 and 19, a block similar to a block illustrated in FIG. 1 is assigned with an identical reference sign, and description therefor will be omitted.

As illustrated in FIG. 18, a volume measurement device 3a includes a first distance data acquisition unit 11, a second distance data acquisition unit 12, a first identifying unit 13, a second identifying unit 14, and a volume measurement unit 15. In other words, the main portion of the volume measurement device 3a is configured by the first distance data acquisition unit 11, the second distance data acquisition unit 12, the first identifying unit 13, the second identifying unit 14, and the volume measurement unit 15. Herein, a first distance sensor 1 and a second distance sensor 2 may be provided outside the volume measurement device 3a (not illustrated in FIG. 18). Further, an output control unit 16 and an output device 4 may be provided outside the volume measurement device 3a (not illustrated in FIG. 18).

As illustrated in FIG. 19, a volume measurement system 100a includes a first distance data acquisition unit 11, a second distance data acquisition unit 12, a first identifying unit 13, a second identifying unit 14, and a volume measurement unit 15. In other words, the main portion of the volume measurement system 100a is configured by the first distance data acquisition unit 11, the second distance data acquisition unit 12, the first identifying unit 13, the second identifying unit 14, and the volume measurement unit 15. Herein, a first distance sensor 1 and a second distance sensor 2 may be provided outside the volume measurement system 100a (not illustrated in FIG. 19). Further, an output control unit 16 and an output device 4 may be provided outside the volume measurement system 100a (not illustrated in FIG. 19).

An advantageous effect similar to that described in the first example embodiment can be acquired as follows, by using the volume measurement device 3a. Further, an advantageous effect similar to that described in the first example embodiment can be acquired as follows, by using the volume measurement system 100a.

That is, the first distance data acquisition unit 11 acquires first distance data acquired by the first distance sensor 1 that irradiates a bed of a freight vehicle FV with a first searching wave from above. The second distance data acquisition unit 12 acquires second distance data acquired by the second distance sensor 2 that irradiates at least one of a back surface portion and a side surface portion of the bed and a ground surface around the freight vehicle FV with a second searching wave. The first identifying unit 13 identifies a frame (bed frame) associated with a peripheral wall portion of the bed by using the first distance data. The second identifying unit 14 identifies a position (bottom surface height D1) of a bottom surface portion of the bed relative to the ground surface by using the second distance data. The volume measurement unit 15 measures a volume V of a load on the bed by using the first distance data, based on a result of identification by the first identifying unit 13 and the second identifying unit 14.

At this time, need for measurement by the distance sensor (the first distance sensor 1 and the second distance sensor 2) in an unloaded state can be eliminated by identifying the bottom surface height D1 by using the second distance data, upon measuring the volume V.

Note that, the volume measurement system 100a may include the output control unit 16 in addition to the first distance data acquisition unit 11, the second distance data acquisition unit 12, the first identifying unit 13, the second identifying unit 14, and the volume measurement unit 15. Each unit of the volume measurement system 100a may be configured by an independent device. For example, the first distance data acquisition unit 11 and the first identifying unit 13 may be configured by a first computer, the second distance data acquisition unit 12 and the second identifying unit 14 may be configured by a second computer, and the volume measurement unit 15 and the output control unit 16 may be configured by a third computer. The individual computer may use a personal computer (PC). The computers may be connected communicably with one another by using a switching hub, a local area network (LAN) cable, and the like.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. This application is based upon and claims the benefit of priority from Japanese patent application No. 2021-107252, filed on Jun. 29, 2021, the disclosure of which is incorporated herein in its entirety by reference.

The whole or part of the example embodiments described above can be described as, but not limited to, the following supplementary notes.

### [Supplementary Notes]

### [Supplementary Note 1]

A volume measurement device including:
a first distance data acquisition unit that acquires first distance data acquired by a first distance sensor that irradiates a bed of a freight vehicle with a first searching wave from above;
a second distance data acquisition unit that acquires second distance data acquired by a second distance sensor that irradiates at least one of a back surface portion and a side surface portion of the bed and a ground surface around the freight vehicle with a second searching wave;
a first identifying unit that identifies a frame associated with a peripheral wall portion of the bed by using the first distance data;
a second identifying unit that identifies a position of a bottom surface portion of the bed relative to the ground surface by using the second distance data; and
a volume measurement unit that measures a volume of a load on the bed by using the first distance data, based on a result of identification by the first identifying unit and the second identifying unit.

### [Supplementary Note 2]

The volume measurement device according to supplementary note 1, wherein
the first identifying unit corrects, when a stop direction of the freight vehicle is tilted relative to a predetermined orientation, the first distance data in such a way as to correct a tilt of the stop direction in processing of identifying the frame, and
the volume measurement unit uses the first distance data after correction for measurement of the volume.

### [Supplementary Note 3]

The volume measurement device according to supplementary note 1 or 2, wherein
the first distance data acquisition unit acquires the first distance data acquired by a plurality of times of measurement using the first distance sensor,
the first identifying unit executes processing of identifying the frame by using the first distance data associated with each time of the measurement, and thereby executes processing of identifying the frame a plurality of times, and
the volume measurement unit measures the volume, based on a result of each time of identification by the first identifying unit, thereby executes processing of measuring the volume a plurality of times, and Excludes an Outlier in a Result of the Plurality of Times of Processing.
   [Supplementary note 4]

The volume measurement device according to supplementary note 1 or 2, wherein
the second distance data acquisition unit acquires the second distance data acquired by a plurality of times of measurement using the second distance sensor, and
the second identifying unit executes processing of identifying a position of the bottom surface portion by using the second distance data associated with each time of the measurement, thereby executes processing of identifying a position of the bottom surface portion a plurality of times, and excludes an outlier in a result of the plurality of times of processing.
   [Supplementary note 5]

The volume measurement device according to any one of supplementary notes 1 to 4, further including an output control unit that executes control of outputting information indicating a result of measurement by the volume measurement unit.

[Supplementary note 6]

The volume measurement device according to any one of supplementary notes 1 to 5, wherein
each of the first distance sensor and the second distance sensor uses 3D-LiDAR, and
each of the first searching wave and the second searching wave is laser light.
   [Supplementary note 7]

A volume measurement system including:
a first distance data acquisition unit that acquires first distance data acquired by a first distance sensor that irradiates a bed of a freight vehicle with a first searching wave from above;
a second distance data acquisition unit that acquires second distance data acquired by a second distance sensor that irradiates at least one of a back surface portion and a side surface portion of the bed and a ground surface around the freight vehicle with a second searching wave;
a first identifying unit that identifies a frame associated with a peripheral wall portion of the bed by using the first distance data;
a second identifying unit that identifies a position of a bottom surface portion of the bed relative to the ground surface by using the second distance data; and
a volume measurement unit that measures a volume of a load on the bed by using the first distance data, based on a result of identification by the first identifying unit and the second identifying unit.
   [Supplementary note 8]

The volume measurement system according to supplementary note 7, further including:
the first distance sensor; and
the second distance sensor.
   [Supplementary note 9]

A volume measurement method including:
acquiring, by a first distance data acquisition unit, first distance data acquired by a first distance sensor that irradiates a bed of a freight vehicle with a first searching wave from above;
acquiring, by a second distance data acquisition unit, second distance data acquired by a second distance sensor that irradiates at least one of a back surface portion and a side surface portion of the bed and a ground surface around the freight vehicle with a second searching wave;
identifying, by a first identifying unit, a frame associated with a peripheral wall portion of the bed by using the first distance data;
identifying, by a second identifying unit, a position of a bottom surface portion of the bed relative to the ground surface by using the second distance data; and
measuring, by a volume measurement unit, a volume of a load on the bed by using the first distance data, based on a result of identification by the first identifying unit and the second identifying unit.
   [Supplementary note 10]

A program for causing a computer to function as:
a first distance data acquisition unit that acquires first distance data acquired by a first distance sensor that irradiates a bed of a freight vehicle with a first searching wave from above;
a second distance data acquisition unit that acquires second distance data acquired by a second distance sensor that irradiates at least one of a back surface portion and a side surface portion of the bed and a ground surface around the freight vehicle with a second searching wave;
a first identifying unit that identifies a frame associated with a peripheral wall portion of the bed by using the first distance data;
a second identifying unit that identifies a position of a bottom surface portion of the bed relative to the ground surface by using the second distance data; and
a volume measurement unit that measures a volume of a load on the bed by using the first distance data, based on a result of identification by the first identifying unit and the second identifying unit.
   [Supplementary note 11]

A recording medium recording the program according to supplementary note 10.

### REFERENCE SIGNS LIST

1 First distance sensor
2 Second distance sensor
3, 3a Volume measurement device
4 Output device
11 First distance data acquisition unit
12 Second distance data acquisition unit
13 First identifying unit
14 Second identifying unit
15 Volume measurement unit
16 Output control unit
21 Computer
31 Processor
32 Memory
33 Processing circuit
100, 100a Volume measurement system

What is claimed is:

1. A volume measurement device comprising:
at least one memory configured to store instructions; and at least one processor configured to execute the instructions to
acquire first distance data acquired by a first distance sensor that irradiates a bed of a freight vehicle with a first searching wave from above,
acquire second distance data acquired by a second distance sensor that irradiates at least one of a back surface portion and a side surface portion of the bed and a ground surface around the freight vehicle with a second searching wave,
identify a frame associated with a peripheral wall portion of the bed by using the first distance data,
identify a position of a bottom surface portion of the bed relative to the ground surface by using the second distance data, and
measure a volume of a load on the bed by using the first distance data, based on a result of identification of the frame and the position of the bottom surface portion of the bed.

2. The volume measurement device according to claim 1, wherein
the at least one processor corrects, when a stop direction of the freight vehicle is tilted relative to a predetermined orientation, the first distance data in such a way as to correct a tilt of the stop direction in processing of identifying the frame, and
the at least one processor uses the first distance data after correction for measurement of the volume.

3. The volume measurement device according to claim 1, wherein
the at least one processor acquires the first distance data acquired by a plurality of times of measurement using the first distance sensor,
the at least one processor executes processing of identifying the frame by using the first distance data associated with each time of the measurement, and thereby executes processing of identifying the frame a plurality of times, and
the at least one processor measures the volume, based on a result of each time of identification by the first identifying unit, thereby executes processing of measuring the volume a plurality of times, and excludes an outlier in a result of the plurality of times of processing.

4. The volume measurement device according to claim 1, wherein
the at least one processor acquires the second distance data acquired by a plurality of times of measurement using the second distance sensor, and
the at least one processor executes processing of identifying a position of the bottom surface portion by using the second distance data associated with each time of the measurement, thereby executes processing of identifying a position of the bottom surface portion a plurality of times, and excludes an outlier in a result of the plurality of times of processing.

5. The volume measurement device according to claim 1, wherein
the at least one processor executes control of outputting information indicating a result of measurement of the volume of the load on the bed.

6. The volume measurement device according to claim 1, wherein
each of the first distance sensor and the second distance sensor uses 3D-LiDAR, and
each of the first searching wave and the second searching wave is laser light.

7. A volume measurement system comprising:
at least one memory configured to store instructions; and at least one processor configured to execute the instructions to
acquire first distance data acquired by a first distance sensor that irradiates a bed of a freight vehicle with a first searching wave from above,
acquire second distance data acquired by a second distance sensor that irradiates at least one of a back surface portion and a side surface portion of the bed and a ground surface around the freight vehicle with a second searching wave,
identify a frame associated with a peripheral wall portion of the bed by using the first distance data,
identify a position of a bottom surface portion of the bed relative to the ground surface by using the second distance data, and
measure a volume of a load on the bed by using the first distance data, based on a result of identification of the frame and the position of the bottom surface portion of the bed.

8. The volume measurement system according to claim 7, further comprising:
the first distance sensor; and
the second distance sensor.

9. A volume measurement method comprising:
acquiring, by at least one memory configured to store instructions; and at least one processor configured to execute the instructions, first distance data acquired by a first distance sensor that irradiates a bed of a freight vehicle with a first searching wave from above;
acquiring, by the at least one processor, second distance data acquired by a second distance sensor that irradiates at least one of a back surface portion and a side surface portion of the bed and a ground surface around the freight vehicle with a second searching wave;
identifying, by the at least one processor, a frame associated with a peripheral wall portion of the bed by using the first distance data;
identifying, by the at least one processor, a position of a bottom surface portion of the bed relative to the ground surface by using the second distance data; and
measuring, by the at least one processor, a volume of a load on the bed by using the first distance data, based on a result of identification by the first identifying unit and the second identifying unit.

10. (canceled)

11. The volume measurement device according to claim 2, wherein
the at least one processor acquires the first distance data acquired by a plurality of times of measurement using the first distance sensor,
the at least one processor executes processing of identifying the frame by using the first distance data associated with each time of the measurement, and thereby executes processing of identifying the frame a plurality of times, and
the at least one processor measures the volume, based on a result of each time of identification by the first identifying unit, thereby executes processing of measuring the volume a plurality of times, and excludes an outlier in a result of the plurality of times of processing.

12. The volume measurement device according to claim 2, wherein
the at least one processor acquires the second distance data acquired by a plurality of times of measurement using the second distance sensor, and
the at least one processor executes processing of identifying a position of the bottom surface portion by using the second distance data associated with each time of the measurement, thereby executes processing of identifying a position of the bottom surface portion a plurality of times, and excludes an outlier in a result of the plurality of times of processing.

13. The volume measurement device according to claim 2, wherein
the at least one processor executes control of outputting information indicating a result of measurement of the volume of the load on the bed.

14. The volume measurement device according to claim 3, wherein
the at least one processor executes control of outputting information indicating a result of measurement of the volume of the load on the bed.

15. The volume measurement device according to claim 4, wherein
the at least one processor executes control of outputting information indicating a result of measurement of the volume of the load on the bed.

16. The volume measurement device according to claim 2, wherein
each of the first distance sensor and the second distance sensor uses 3D-LiDAR, and
each of the first searching wave and the second searching wave is laser light.

17. The volume measurement device according to claim 3, wherein
each of the first distance sensor and the second distance sensor uses 3D-LiDAR, and
each of the first searching wave and the second searching wave is laser light.

18. The volume measurement device according to claim 4, wherein
each of the first distance sensor and the second distance sensor uses 3D-LiDAR, and
each of the first searching wave and the second searching wave is laser light.

19. The volume measurement device according to claim 5, wherein
each of the first distance sensor and the second distance sensor uses 3D-LiDAR, and
each of the first searching wave and the second searching wave is laser light.
